(19) United States
(12) Patent Application Publication
(10) Pub. No.: US 2019/0273845 A1
(43) Pub. Date: Sep. 5, 2019

(54) VIBRATION MONITORING OF AN OBJECT USING A VIDEO CAMERA

(71) Applicant: PRÜFTECHNIK Dieter Busch AG, Ismaning (DE)

(72) Inventor: Oliver Jährig, Ismaning (DE)

(21) Appl. No.: 16/291,966

(22) Filed: Mar. 4, 2019

(30) Foreign Application Priority Data
Mar. 5, 2018 (DE) 102018104913.7

(51) Int. Cl. H04N 5/14; H04N 5/272; H04N 7/01; G01H 9/00

(52) U.S. Cl. CPC H04N 5/144; G01H 9/00; H04N 7/0117; H04N 5/272

(57) ABSTRACT

The invention relates to a method for vibration monitoring of an object (12), wherein, by means of a video camera (14), video data of at least one region of the object is acquired in the form of a plurality of frames; pixel speeds are determined for each frame from the video data; a pixel kinetic energy is determined for each pixel from the determined pixel speeds of the frames; a single frame is established from the video data; a depiction threshold for the determined pixel kinetic energies is established; and a depiction is output in which the single frame is superimposed with a depiction of the distribution of the determined pixel kinetic energies, wherein, for pixels whose determined kinetic energy lies below the depiction threshold, no depiction of the kinetic energy occurs.

The present invention relates to a method and a system for vibration monitoring of an object.

The detection and analysis of vibrations is an essential part of monitoring the state of vibrating objects, in particular machines or machine parts. A possibility for vibration detection consists in the use of vibration sensors attached to the machine housing. However, this permits only point measurements in certain regions of the machine.

A spatially more detailed vibration analysis is offered by imaging methods, wherein, by means of video analysis, the motion of image points and thus also of vibration intensities can be determined. Video-based methods for detecting the motion of image points are described, for example, in US 2016/0217588 A1.

Furthermore, it is known how to process video data in such a way that the motion of image points is displayed in an amplified manner, so that motions with small displacements are more clearly visible to the observer. Examples of such motion amplification methods are named, for example, in U.S. Pat. No. 9,338,331 B2, US 2016/0300341 A1, WO 2016/196909 A1, US 2014/0072190 A1, US 2015/0215584 A1, and U.S. Pat. No. 9,324,005 B2. Furthermore, the company RDI Technologies, Inc., Knoxville, USA, markets a system under the name “Iris M,” which, can display, in an amplified manner, object motions recorded by means of a video camera, wherein, for manually selectable interesting regions of the object, time courses and frequency spectra can be displayed.

The object of the present invention is to create a method and a system for vibration monitoring of objects that is user-friendly and can deliver informative results in a graphically descriptive way.

This object is achieved in accordance with the invention by a method according to claim 1 and by a system according to claim 15.

In the solution according to the invention, a depiction of the object is output in which a depiction of the distribution of the pixel kinetic energies determined from the video data is superimposed on a single frame that is established from the video data, wherein, for pixels whose determined kinetic energy lies below a depiction threshold, no depiction of the kinetic energy occurs. Through such a partially transparent depiction of the object with the determined vibration intensities, a direct visibility of vibrationally relevant regions is achieved, which, in particular, also makes possible a good overall view in terms of the vibration intensities of a complex object. Preferred embodiments of the invention are presented in the dependent claims.

In the following, the invention will be explained in detail on the basis of the appended drawings by example. Shown are:

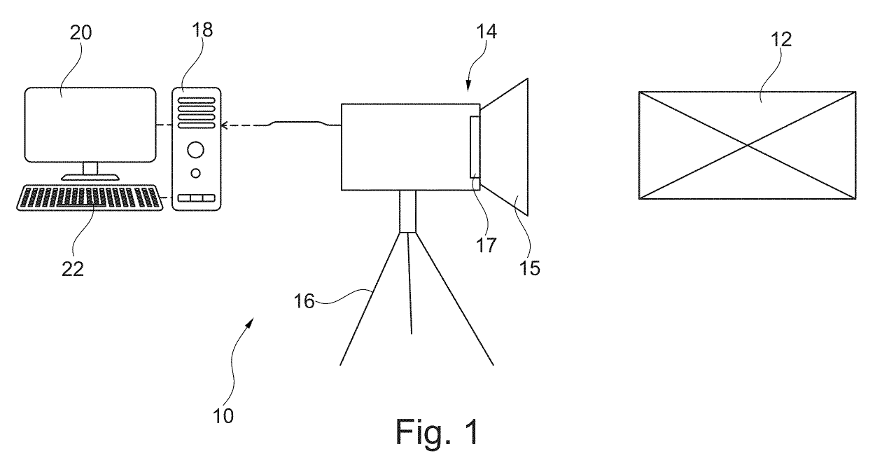

FIG. 1 a schematic depiction of an example of a system for vibration monitoring of an object;

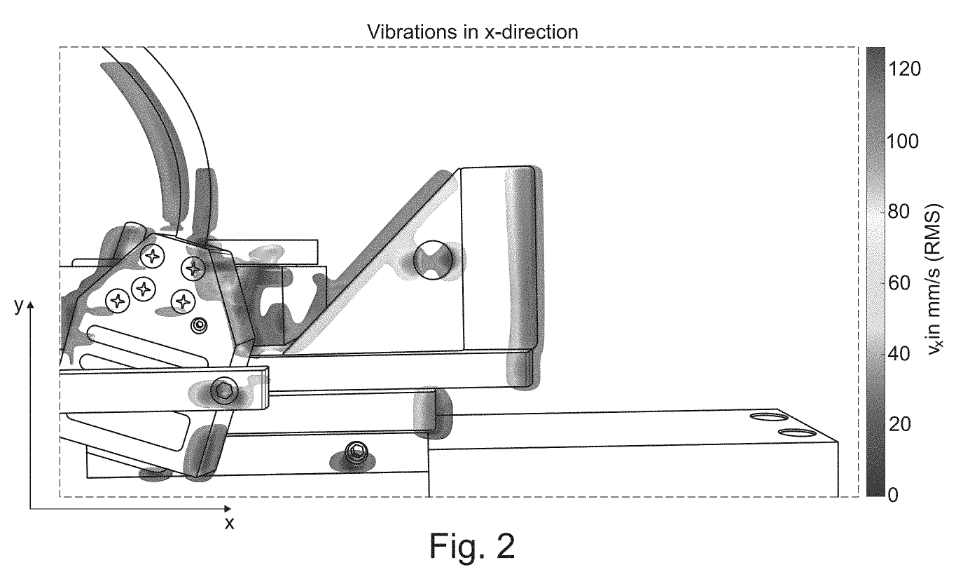

FIG. 2 an example of the depiction of the vibration energy of an object in the x direction by the system of FIG. 1;

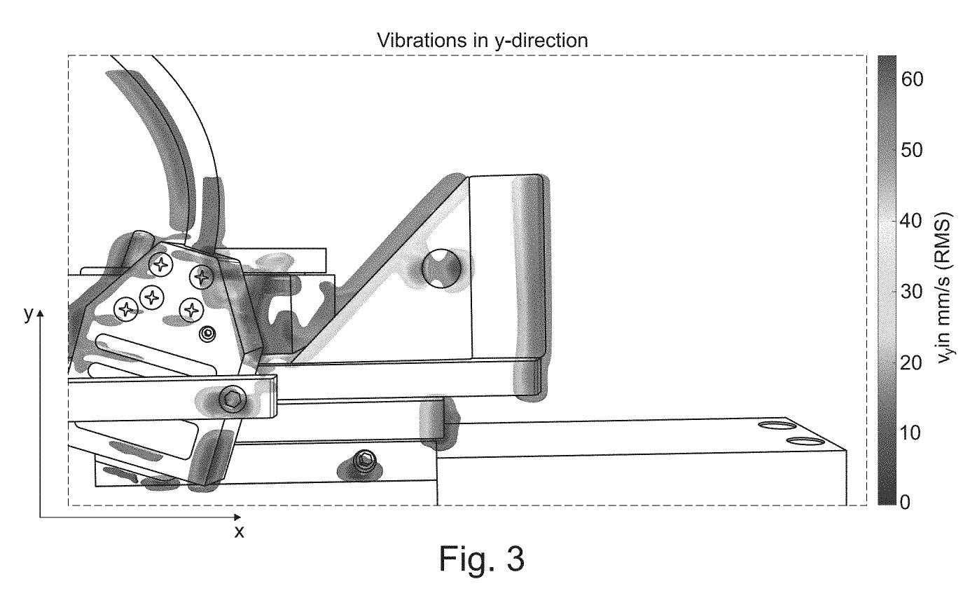

FIG. 3 a view like that in FIG. 2, in which, however, the vibration energy in the y direction is depicted;

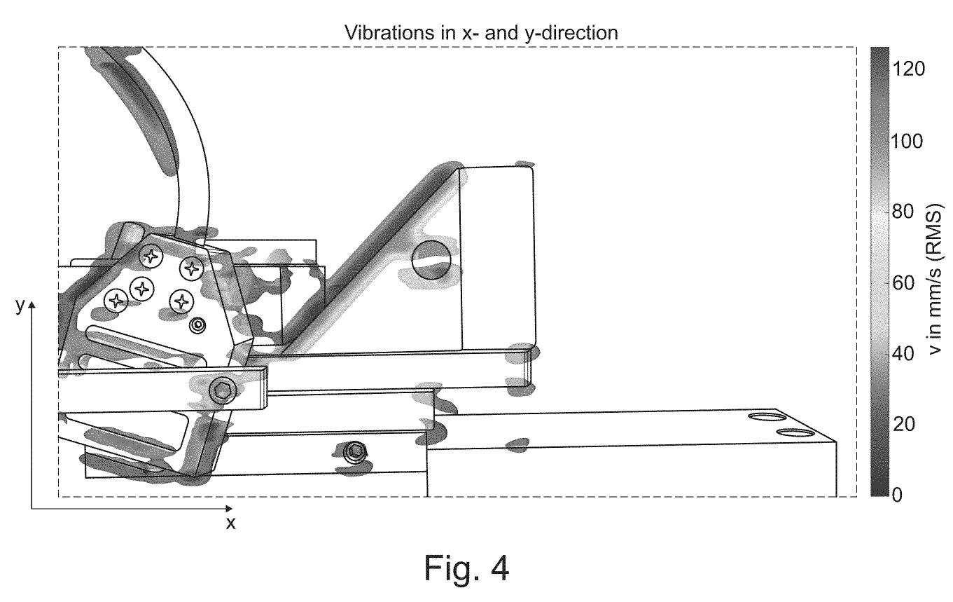

FIG. 4 a view like that in FIGS. 2 and 3, in which, however, the total vibration energy in the x direction and in the y direction is depicted; and

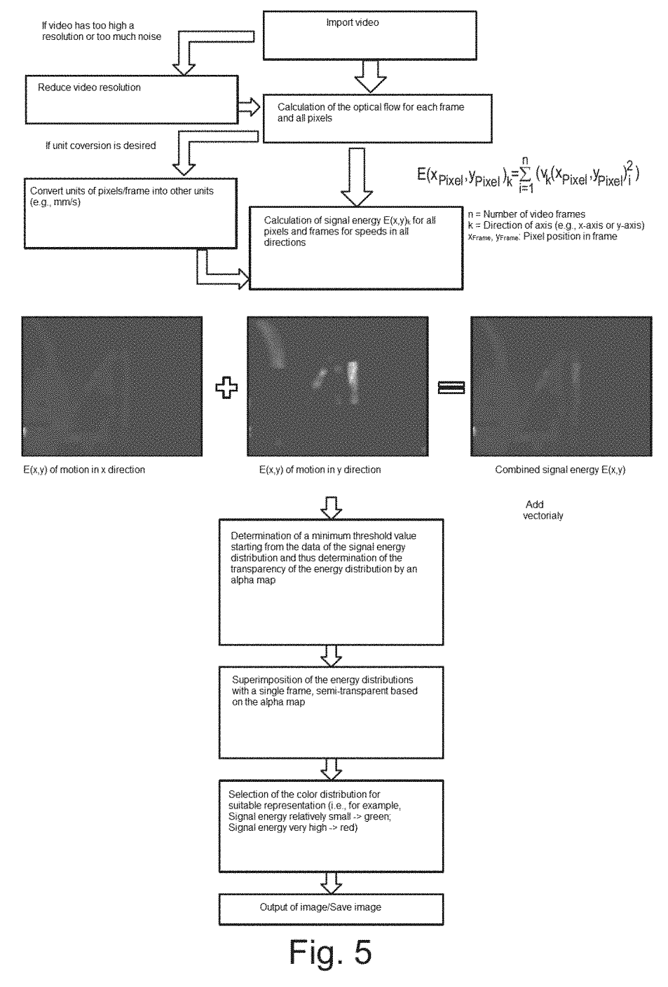

FIG. 5 a flow chart of an example of a method for vibration monitoring of an object.

Shown schematically in FIG. 1 is an example of a system 10 for vibration monitoring of an object 12. The object can be, for example, a machine, such as, for example, a rotating machine, or a machine component. The system 10 comprises a video camera 14 with a tripod 16, which is connected to a data processing device 18, as well as an output device 20 for graphic depiction of measurement results. The video camera 14 has a lens 15 and an image sensor 17. The data processing device 18 also typically comprises a user interface 22 in order to input data and/or commands into the data processing device 18. The data processing device 18 can be designed, for example, as a personal computer, a notebook, or a tablet computer. Typically, the output device can be a display screen.

By means of the video camera 14, video data of at least one region of the object 12 are acquired in the form of a plurality of frames. For the evaluation of the video data, the data are initially transferred to or read into the data processing device 18 from the camera 14.

If necessary, in particular if the video has too great a resolution or too much noise, a reduction of the video resolution can be performed, in particular by use of convolution matrixes. This can occur, for example, by using a suitable pyramid, such as, for example, a Gaussian pyramid. In such a known method, the original image represents the bottommost pyramid stage and the next higher stage is generated in each case by the image and the following downsampling of the smoothed image, wherein, in the x and y directions, the resolution is reduced in each case by a factor of 2 (in this way, the effect of a spatial low-pass filter is achieved, with the number of pixels being reduced by half in each dimension). For a three-stage pyramid, the resolution is then correspondingly reduced in each dimension by a factor of 8. In this way, the accuracy of the following speed calculation can be increased, because interfering noise is minimized. This reduction in resolution is performed for each frame of the read-in video, provided that the spatial resolution of the video data exceeds a certain threshold and/or the noise of the video data exceeds a certain threshold.

Furthermore, prior to the evaluation, the video can be processed by a motion amplification algorithm (motion amplification), by which motions are depicted in amplified form, so that the observer can also recognize even small displacements in motion. Insofar as a reduction in the video resolution is performed, the application of the motion amplification algorithm takes place prior to the reduction of the video resolution.

In the next step, for each frame and all pixels of the original video or of the resolution-reduced videos, the optical flow is determined; this preferably occurs by using a Lucas-Kanade method (in this case, two successive frames are always compared with each other), but it is also fundamentally possible to use other methods. As a result, the current pixel speed for each pixel is obtained in units of “pixels/frame” for each frame. Because, in a video, the frames are recorded at constant time intervals, the frame number corresponds to the physical parameter “time.” Ultimately, therefore, the speed calculation affords a 3D array with the two spatial coordinates x and y, which specify the pixel position, as well as the third dimension “time,” which is given by the frame number.

In the next step, for each pixel, a representative value for the pixel kinetic energy—and thus for the vibration intensity in this pixel—is determined on the basis of the determined pixel motion speeds of all frames (referred to below as a “pixel kinetic energy”); this can occur, for example, as RMS (root mean square) of the pixel speeds of the individual frames; that is, the pixel kinetic energy is obtained as a square root of a normalized quadratic sum of the speeds for these pixels in the individual frames (in this case, the quadratic sum of the speeds of the pixels in each frame is divided by the total number of frames minus one, wherein the square root of the value thus determined is then taken).

The pixel kinetic energy is calculated here separately for two different orthogonal vibration directions; that is, in the preceding step, the optical flow, that is, the pixel speed is calculated separately for each frame and all pixels in the x direction and in the y direction, and, from the pixel speed in the x direction, the RMS of the pixel speed is then determined in the x direction, and, from the optical flow, that is, the pixel speed, in the y direction, the RMS of the pixel speed in the y direction is calculated. Thus obtained is a 2D array with the pixel kinetic energies in the x direction and a 2D array with the pixel kinetic energy in the y direction. From these two individual arrays, it is possible by vectorial addition to determine a combined pixel kinetic energy or total pixel kinetic energy.

The determined pixel kinetic energy is preferably converted to a physical speed unit, that is, path/time (from the unit pixels/frame, which is obtained from the optical flow), so that, for example, the unit mm/s is obtained (as mentioned above, “pixel kinetic energy” refers to a quantity that is representative for the vibration energy in a pixel; this does not need to have any physical energy unit, but can be, for example, the square root of a physical energy, as in the above RMS example).

In accordance with a first example, such a conversion can occur in that a dimension of an element depicted in the video frames is determined physically (for example, by means of yardstick, ruler, or caliper) and, namely, is carried out in the x direction and y direction and is then compared with the corresponding pixel extent of this element in the x direction and y direction in the video frames. If, prior to the calculation of the optical flow, the image was reduced in its resolution, that is, was reduced in size, then this still needs to be taken into consideration through a corresponding scaling factor. On the basis of the number of frames per second, the unit “frames” can be converted into seconds (this information can be read out of the video file).

If, prior to the evaluation, the video was processed by a motion amplification algorithm, this needs to be taken into consideration in the unit conversion through a corresponding correction factor.

Another possibility for conversion of the units consists in the use of data relating to the optics of the camera and the distance to the recorded object. The object width of an element depicted in the video frames is determined here, and, furthermore, the focal length of the video camera lens 15 and the physical dimension of a pixel of the sensor 17 of the video camera 14 are taken into consideration in order to determine the physical dimension of the depicted element and to compare it with the pixel extent of the element in the video frames.

Provided that, prior to the calculation of the optical flow, a reduction in the video resolution has taken place, the individual 2D arrays of the pixel kinetic energies (x direction, y direction, x direction and y direction combined) are extrapolated back to the original resolution of the video (during this upsampling, if values smaller than zero occur, they are set identical to zero in the pixels in question).

Subsequently, the output of the thus determined pixel kinetic energy distributions (x direction, y direction, x direction and y direction combined) is prepared in that a single frame is determined from the video data and a depiction threshold of the pixel energy is established, wherein a superimposition of the respective pixel kinetic energy distribution with the single frame then results in a semi-transparent manner corresponding to the depiction threshold on the basis of a so-called “alpha map.” In this case, the pixel kinetic energies are preferably depicted in a color-coded manner; that is, certain color grades correspond to certain ranges of the values for the pixel kinetic energies (for example, relatively low pixel kinetic energies can be depicted in green, medium pixel kinetic energies in yellow, and high pixel kinetic energies in red). For pixels whose determined kinetic energy lies below the depiction threshold, no depiction of the kinetic energy occurs in the superimposition with the single frame: that is, for pixels whose kinetic energy lies below the depiction threshold, the depiction remains completely transparent. The superimposed image is then output to the user via the display screen 20, for example, and it can be saved and/or further distributed via corresponding interfaces/communication networks.

The single frame used for the superimposition can be selected simply, for example, from the video frames (for example, the first frame is taken) or the single frame is determined by processing a plurality of video frames as a median image, for example. Because vibration displacements are typically relatively rare, the selection of the single frame is, as a rule, not critical (although the determination of a median image from the mean values of the intensities is more complicated, the median image also has less noise than an individual image).

The depiction threshold can be selected manually by the user, for example, or it can be established automatically as a function of at least one key index of the pixel kinetic energies. By way of example, the depiction threshold can depend on a mean value of the pixel kinetic energies and the standard deviation of the pixel kinetic energies. In particular, the depiction threshold can lie between the mean value of the pixel kinetic energies and the mean value of the pixel kinetic energies plus three times the standard deviation of the pixel kinetic energies (for example, the depiction threshold can correspond to the mean value of the pixel kinetic energies plus the standard deviation of the pixel kinetic energy).

Shown in FIG. 5 is a flow chart for an example of a method for vibration monitoring of an object using video analysis. The semi-transparent superimposition of the pixel kinetic energies with a single frame that is output by the method can be used as an input in a conventional vibration monitoring method in which this data is inspected by a user, for example.

Seen in FIGS. 2 to 4 is an example of a semi-transparent superimposed depiction of a single frame of a machine part with pixel kinetic energy distributions in the x direction, y direction, or in combined x direction and y direction.

1. A method for vibration monitoring of an object (12), wherein
by means of a video camera (14), video data of at least one region of the object is acquired in the form of a plurality of frames;
pixel speeds are determined for each frame from the video data;
a pixel kinetic energy is determined for each pixel from the determined pixel speeds of the frames;
a single frame is established from the video data;
a depiction threshold for the determined pixel kinetic energies is established; and
a depiction is output in which the single frame is superimposed with a depiction of the distribution of the determined pixel kinetic energies, wherein, for pixels whose determined kinetic energy lies below the depiction threshold, no depiction of the kinetic energy occurs.

2. The method according to claim 1, further characterized in that the depiction threshold is established manually or as a function of at least one key index of the pixel kinetic energies.

3. The method according to claim 2, further characterized in that the depiction threshold depends on a mean value of the pixel kinetic energies and the standard deviation of the pixel kinetic energies.

4. The method according to claim 3, further characterized in that the depiction threshold lies between the mean value of the pixel kinetic energies and the mean value of the pixel kinetic energies plus 3 times the standard deviation of the pixel kinetic energies.

5. The method according to claim 1, further characterized in that, prior to the determination of the pixel speeds, the video data is reduced in terms of its spatial resolution, in particular by use of convolution matrices, such as, for example, in the form of a Gaussian pyramid, if the spatial resolution of the video data exceeds a threshold, and/or the noise of the video data exceeds a threshold.

6. The method according to claim 1, further characterized in that, in the determination of the pixel speeds, the optical flow is determined for each pixel.

7. The method according to claim 6, further characterized in that the optical flow is determined by means of a Lucas-Kanade method.

8. The method according to claim 1, further characterized in that the pixel kinetic energy is calculated for each pixel as a RMS of the pixel speeds, wherein the pixel kinetic energy is obtained as a square root from a normalized quadratic sum of the pixel speeds.

9. The method according to claim 1, further characterized in that the pixel kinetic energy is calculated separately for at least two different, in particular orthogonal, vibration directions, wherein the pixel kinetic energy is depicted separately for the different vibration directions and/or is depicted as a total pixel kinetic energy by addition of the pixel kinetic energy for the different vibration directions.

10. The method according to claim 1, further characterized in that the determined pixel kinetic energy is converted to a physical speed unit as path/time.

11. The method according to claim 10, further characterized in that, in the conversion of the determined pixel kinetic energy to a physical speed unit, a dimension of an element (12) depicted in the video frames is determined physically and is compared to the pixel extent of the element in the video frames.

12. The method according to claim 10, further characterized in that, in the conversion of the determined pixel kinetic energy to a physical speed unit, the object width of an element depicted in the video frames is determined and, furthermore, the focal length of the lens (15) of the video camera (14) and the physical dimension of a pixel of the sensor (17) of the video camera are taken into consideration, in order to determine a physical dimension of the element and to compare it to the pixel extent of the element in the video frames.

13. The method according to claim 1, further characterized in that the single frame is selected from the plurality of video frames or is determined as a median image from the video frames.

14. The method according to claim 1, further characterized in that the pixel kinetic energies are depicted in a color-coded manner, wherein certain color grades are assigned to certain ranges of the values of the pixel kinetic energies.

15. A system for vibration monitoring of an object (12), comprising:
a video camera (14) for acquiring video data of at least one region of the object in the form of a plurality of frames,
a data processing unit (18) for determining pixel speeds from the video data for each frame, for determining pixel kinetic energies for each pixel from the pixel speeds of the frames, and for establishing a depiction threshold of the pixel kinetic energy, as well as
an output unit (18, 20) for superimposition of a single frame determined from the video data with a depiction of the distribution of the pixel kinetic energy, wherein, for pixels whose kinetic energy lies below the depiction threshold, no depiction of the kinetic energy occurs.
